(19) United States
(12) Patent Application Publication
(10) Pub. No.: US 2019/0383056 A1
(43) Pub. Date: Dec. 19, 2019

(54) Lockable Door Hardware Assembly

(71) Applicants: Thomas Ouellette, East Freetown, MA (US); Roberta Ouellette, East Freetown, MA (US)

(72) Inventors: Thomas Ouellette, East Freetown, MA (US); Roberta Ouellette, East Freetown, MA (US)

(21) Appl. No.: 16/009,599

(22) Filed: Jun. 15, 2018

(51) Int. Cl. E05B 15/12; E05C 19/18

(52) U.S. Cl. CPC E05B 17/2023; E05C 19/184

(57) ABSTRACT

A lockable door hardware assembly for securing a door in closed configuration includes a mortice lock that is coupled to a door. The mortice lock comprises a latch bolt, which in turn comprises a head and a shaft. The head is circumferentially larger than the shaft. A strike plate is mounted to a doorframe in which the door is positioned. A channel extends into the door from an interior surface of the door so that the head of the latch bolt is positioned between the doorframe and the channel when the latch bolt is extended through the strike plate. A rod is selectively insertable into the channel. The rod is positioned to abut the head of the latch bolt to prevent the latch bolt from retracting from the strike plate, thereby rendering the door unlockable from either side of the door.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to door hardware assemblies and more particularly pertains to a new door hardware assembly for securing a door in closed configuration.

### BRIEF SUMMARY OF THE INVENTION

An embodiment of the disclosure meets the needs presented above by generally comprising a mortice lock that is coupled to a door. The mortice lock comprises a latch bolt, which in turn comprises a head and a shaft. The head is circumferentially larger than the shaft. A strike plate is mounted to a doorframe in which the door is positioned. A channel extends into the door from an interior surface of the door so that the head of the latch bolt is positioned between the doorframe and the channel when the latch bolt is extended through the strike plate. A rod is selectively insertable into the channel. The rod is positioned to abut the head of the latch bolt to prevent the latch bolt from retracting from the strike plate, thereby rendering the door unlockable from either side of the door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a lockable door hardware assembly according to an embodiment of the disclosure.

FIG. 2 is an in-use view of an embodiment of the disclosure.

FIG. 3 is a side view of an embodiment of the disclosure.

FIG. 4 is a detail view of an embodiment of the disclosure.

FIG. 5 is a cross-sectional view of an embodiment of the disclosure.

### DETAILED DESCRIPTION OF THE INVENTION

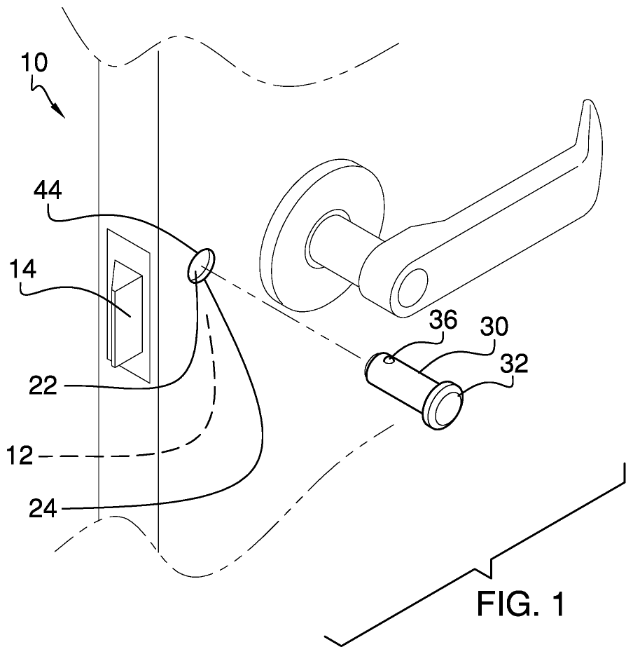

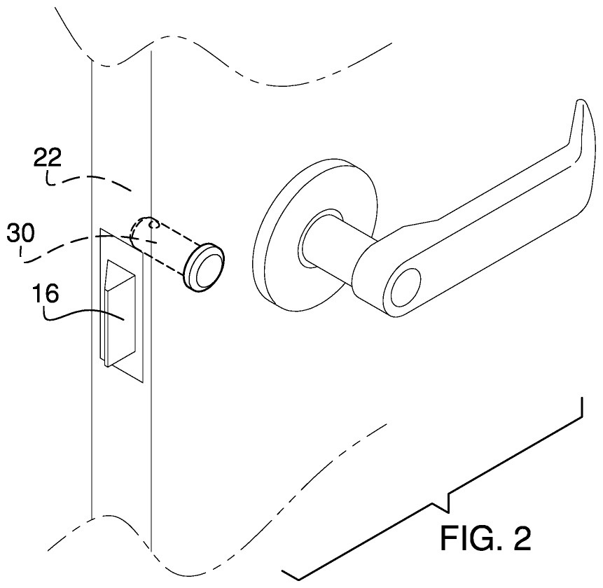

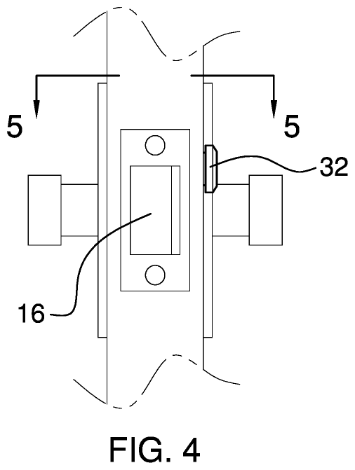

With reference now to the drawings, and in particular to FIGS. 1 through 5 thereof, a new door hardware assembly embodying the principles and concepts of an embodiment of the disclosure and generally designated by the reference numeral 10 will be described.

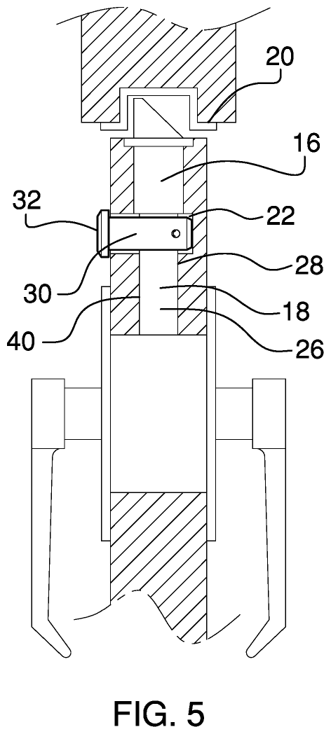

As best illustrated in FIGS. 1 through 5, the lockable door hardware assembly 10 generally comprises a mortice lock 12 that is coupled to a door. The mortice lock 12 comprises a latch bolt 14, which in turn comprises a head 16 and a shaft 18. The head 16 is circumferentially larger than the shaft 18. A strike plate 20 is mounted to a doorframe in which the door is positioned, as shown in FIG. 5.

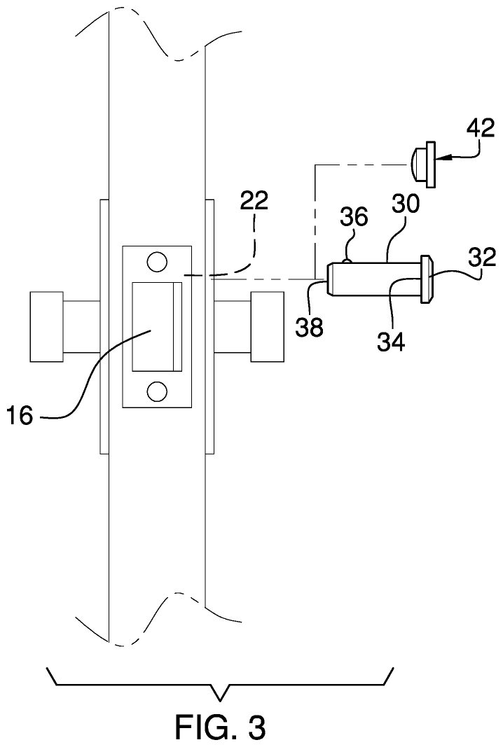

A channel 22 extends into the door from an interior surface of the door, as shown in FIG. 1, so that the head 16 of the latch bolt 14 is positioned between the doorframe and the channel 22 when the latch bolt 14 is extended through the strike plate 20, as shown in FIG. 5. The channel 22 is positioned in the door so that a lower limit 24 of the channel 22 is in substantial alignment with an upper edge 26 of the latch bolt 14, as shown in FIG. 3. The channel 22 extends past a distal face 28 of the latch bolt 14.

A rod 30 is selectively insertable into the channel 22, as shown in FIG. 1. The rod 30 is circularly shaped when viewed longitudinally. The rod 30 is positioned to abut the head 16 of the latch bolt 14 to prevent the latch bolt 14 from retracting from the strike plate 20, thereby rendering the door unlockable from either side of the door. In a crisis, such as during a lockdown in a school, a user inserts the rod 30 into the channel 22, preventing retraction of the latch bolt 14 from the strike plate 20, thereby rendering the door unlockable from either side, even with a key to a lock of the door.

A plate 32 is coupled to a first end 34 of the rod 30, as shown in FIG. 3. The plate 32 is configured to abut the interior surface of the door when the rod 30 is inserted into the channel 22. The plate 32 is circularly shaped.

A pin 36 is coupled to and selectively extensible from the rod 30, as shown in FIG. 3. The pin 36 is spring-loaded. The pin 36 is positioned proximate to a second end 38 of the rod 30. The pin 36 is positioned to be depressed as the pin 36 contacts a proximal face 40 of the latch bolt 14 as the rod 30 is inserted into the channel 22. The pin 36 is positioned to extend from the rod 30 to abut the distal face 28 of the latch bolt 14 when the rod 30 is fully inserted into the channel 22 to removably couple the rod 30 to the latch bolt 14, as shown in FIG. 5. The pin 36 prevents the rod 30 from being dislodged from the channel 22 in event of impact to an exterior of the door, for example by a person kicking the door.

The assembly 10 also comprises a plug 42 that is complementary to an opening 44 of the channel 22. The opening 44 is positioned to selectively insert the plug 42 to close the channel 22.

In use during the crisis, the user inserts the rod 30 into the channel 22, preventing retraction of the latch bolt 14 from the strike plate 20, thereby rendering the door unlockable from either side.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lockable door hardware assembly comprising:
a mortice lock coupled to a door, the mortice lock comprising a latch bolt comprising a head and a shaft, the head being circumferentially larger than the shaft;
a strike plate mounted to a doorframe in which the door is positioned;
a channel extending into the door from an interior surface of the door such that the head of the latch bolt is positioned between the doorframe and the channel when the latch bolt is extended through the strike plate; and
a rod selectively insertable into the channel wherein the rod is positioned for abutting the head of the latch bolt preventing the latch bolt from retracting from the strike plate rendering the door unlockable from either side of the door.

2. The assembly of claim 1, further including the channel being positioned in the door such that a lower limit of the channel is in substantial alignment with an upper edge of the latch bolt.

3. The assembly of claim 1, further including the rod being circularly shaped when viewed longitudinally.

4. The assembly of claim 1, further including a plate coupled to a first end of the rod wherein the plate is configured for abutting the interior surface of the door when the rod is inserted into the channel.

5. The assembly of claim 4, further including the plate being circularly shaped.

6. The assembly of claim 4, further including a pin coupled to and selectively extensible from the rod, the pin being spring-loaded, the pin being positioned proximate to a second end of the rod wherein the pin is positioned for depressing as the pin contacts a proximal face of the latch bolt as the rod is inserted into the channel positioning the pin for extending from the rod to abut a distal face of the latch bolt when the rod is fully inserted into the channel for removably coupling the rod to the latch bolt.

7. The assembly of claim 1, further including the channel extending past a distal face of the latch bolt.

8. The assembly of claim 1, further including a plug complementary to an opening of the channel wherein the opening is positioned for selectively inserting the plug for closing the channel.

9. A lockable door hardware assembly comprising:
a mortice lock coupled to a door, the mortice lock comprising a latch bolt comprising a head and a shaft, the head being circumferentially larger than the shaft;
a strike plate mounted to a doorframe in which the door is positioned;
a channel extending into the door from an interior surface of the door such that the head of the latch bolt is positioned between the doorframe and the channel when the latch bolt is extended through the strike plate, the channel being positioned in the door such that a lower limit of the channel is in substantial alignment with an upper edge of the latch bolt, the channel extending past a distal face of the latch bolt;
a rod selectively insertable into the channel wherein the rod is positioned for abutting the head of the latch bolt preventing the latch bolt from retracting from the strike plate rendering the door unlockable from either side of the door, the rod being circularly shaped when viewed longitudinally;
a plate coupled to a first end of the rod wherein the plate is configured for abutting the interior surface of the door when the rod is inserted into the channel, the plate being circularly shaped;
a pin coupled to and selectively extensible from the rod, the pin being spring-loaded, the pin being positioned proximate to a second end of the rod wherein the pin is positioned for depressing as the pin contacts a proximal face of the latch bolt as the rod is inserted into the channel positioning the pin for extending from the rod to abut the distal face of the latch bolt when the rod is fully inserted into the channel for removably coupling the rod to the latch bolt; and
a plug complementary to an opening of the channel wherein the opening is positioned for selectively inserting the plug for closing the channel.
